(19) United States
(12) Patent Application Publication
(10) Pub. No.: US 2013/0027301 A1
(43) Pub. Date: Jan. 31, 2013

(54) OPERATION METHOD AND CONTROL SYSTEM FOR MULTI-TOUCH CONTROL

(71) Applicant: Tsung-Hsien SHEN, New Taipei (TW)

(72) Inventor: Tsung-Hsien SHEN, New Taipei (TW)

(73) Assignee: KYE SYSTEMS CORP., New Taipei (TW)

(21) Appl. No.: 13/554,317

(22) Filed: Jul. 20, 2012

(30) Foreign Application Priority Data
Jul. 29, 2011 (TW) 100127113

(51) Int. Cl. G06F 3/033

(52) U.S. Cl. 345/158

(57) ABSTRACT

An operation method and a control system for multi-touch control are provided. A map positioner and a map block are set in a display region, and the position of a cursor is set according to an input signal of an operation region. The position of a fast positioner set in the operation region corresponds to the position of the map positioner. The position of the cursor is shifted according to a motion vector inputted by an input device, and the position of the map block is reset. The map block and the cursor are shifted to the map positioner when the input device receives a trigger signal of the fast positioner. An object in the map block is selected, a multi-touch function is enabled, and the operation property of the object is changed according to a relative shift quantity formed by a first and a second control points.

### CROSS-REFERENCE TO RELATED APPLICATIONS

This non-provisional application claims priority under 35 U.S.C. §119(a) on Patent Application No(s). 100127113 filed in Taiwan, R.O.C. on Jul. 29, 2011, the entire contents of which are hereby incorporated by reference.

### BACKGROUND

1. Technical Field

The disclosure relates to an operation method and a control system for multi-touch control, and more particularly to an operation method and a control system for multi-touch control among different devices.

2. Related Art

With the development of technology, various input peripheral devices have been widely used, especially touch panels. User can touch the touch panel to select various objects via a finger thereof. The objects may be a window of an application program, a picture or built-in functions of an application program. Notice that Windows 7 promoted by Microsoft Corporation is embedded some functions relating to touch panel. Therefore, user can slide a finger thereof on a touch panel 100 of FIG. 1 to zoom in, zoom out or shift the object 110.

The multi-touch function of Windows 7 is to control the object 110 by shifting multiple fingers, where Microsoft Corporation defines such operations, which are performed by the multi-touch function, as gestures. Currently, the gestures supported by Microsoft Corporation include zoom-in, zoom-out, single finger's shifting, two fingers' shifting, rotation, two fingers' clicking, and the pressing with clicking For example, when user uses two fingers to select any one of pictures on the touch panel, Windows 7 enables the multi-touch function right away. When the relative distance between the two fingers increases, the picture is zoomed in, and on the contrary, the picture is zoomed out.

However, the prime cost of touch display panel is positive proportional to the size thereof. Therefore, the price of touch display panel with large size may be many times of the price of general display panel with the same size. Moreover, it is not necessary for user to own a touch display panel with large size, and it really burdens user to use such a large touch display panel. Therefore, touch device (or touch display device) of smaller size is promoted to control a large display device now.

Although it is easy for user to use a small touch display device, a large coordinate of the large display device is mapped at the small touch device by a pixel mapping manner. This causes the shift quantity of a cursor is too large. The operation region of the small touch device is smaller than the display region of the large display device, so the shift quantity of the cursor is amplified in a certain proportion when the operation region is mapped to the large display device. Accordingly, when user controls the cursor via the small touch device and user's finger even shifts a short distance, the cursor on the large display device may be shifted a long distance. Such a pixel mapping manner may cause user uses such a system inconveniently.

### SUMMARY

The disclosure is an operation method for multi-touch control. Firstly, an operation region of an input device and a display region of a display device are acquired. At least one map positioner and a map block are set in the display region, and the position of the map block is set according to an input signal of the operation region. At least one fast positioner is set in the operation region, and the position of the at least one fast positioner corresponds to the position the at least one map positioner. A motion vector of the cursor is inputted by the input device, the position of the cursor of the display device is shifted according to the motion vector, and the position of the map block is reset. At least one object is selected, and a multi-touch function is enabled, whereby the input device changes the property of the object according to a relative shift quantity formed by a first and a second control points. The input device sets a current position of the cursor as the first control point, and the position of the second control point differs from the position of the first point. When receiving a trigger signal of the at least one fast positioner, the input device shifts the map block and the cursor to the at least one map positioner.

The disclosure provides a control system for multi-touch control, which includes a display device, a computer and an input device. A cursor is drawn in a display region of the display device, and at least one map positioner is set in the display region. The computer is electronically connected to the display device and receives a cursor shift signal to redraw the cursor in the display region. The input device is connected to the computer, displays an operation region which the cursor shift signal is received by, and generates a motion vector of the cursor according to the cursor shift signal. The operation region includes at least one fast positioner, and the position of the at least one fast positioner corresponds to the position of the at least map positioner. When receiving a trigger signal of the at least one fast positioner, the input device shifts the map block and the cursor to the corresponding map positioner.

For purposes of summarizing, some aspects, advantages and features of some embodiments of the disclosure have been described in this summary. Not necessarily all of (or any of) these summarized aspects, advantages or features will be embodied in any particular embodiment of the disclosure. Some of these summarized aspects, advantages and features and other aspects, advantages and features may become more fully apparent from the following detailed description and the appended claims.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic diagram of the multi-touch technology of the prior art;

FIG. 2A is a schematic diagram of an embodiment of the disclosure;

FIG. 2B is a schematic diagram of the display unit of the computer according to an embodiment of the disclosure;

FIG. 3 is a flow chart of an embodiment of the disclosure;

FIG. 4A is a schematic diagram of the map block according to an embodiment of the disclosure;

FIG. 4B is a schematic diagram of the position of the cursor and of the map block according to an embodiment of the disclosure;

FIG. 4C is a schematic diagram of drawing the map block by shifting the cursor according to an embodiment of the disclosure;

FIG. 5A is a flow chart of processing the operation of the cursor according to an embodiment of the disclosure;

FIG. 5B is an operation diagram of an embodiment of the disclosure;

FIG. 5C is an operation diagram of another embodiment of the disclosure;

FIG. 6A is a schematic diagram of the disposement of the object according to an embodiment of the disclosure;

FIG. 6B is a schematic diagram of the disposement of the object according to an embodiment of the disclosure;

FIG. 6C is a schematic diagram of the rotation of the object according to an embodiment of the disclosure;

FIG. 6D is a schematic diagram of the rotation of the object according to an embodiment of the disclosure;

FIG. 7A is a schematic diagram of multiple objects in a map block before shifting according to an embodiment of the disclosure;

FIG. 7B is a schematic diagram of multiple objects in a map block after shifting according to an embodiment of the disclosure;

FIG. 7C is a schematic diagram of multiple objects in a map block before rotating according to an embodiment of the disclosure;

FIG. 7D is a schematic diagram of multiple objects in a map block after rotating according to an embodiment of the disclosure;

FIG. 8A is a schematic diagram of an image of a map block corresponding to an image of an input device before shifting according to an embodiment of the disclosure;

FIG. 8B is a schematic diagram of an image of a map block corresponding to an image of an input device before shifting according to an embodiment of the disclosure;

FIG. 9A is a schematic diagram of a map positioner according to an embodiment of the disclosure;

FIG. 9B is a schematic diagram of a fast positioner according to an embodiment of the disclosure;

FIG. 9C is a flow chart of another embodiment of the disclosure;

FIG. 9D is a schematic diagram of a fast positioner and a map positioner according to an embodiment of the disclosure;

FIG. 10A is a schematic diagram of a map block before switching according to another embodiment of the disclosure;

FIG. 10B is a schematic diagram of a map block after switching according to another embodiment of the disclosure;

FIG. 10C is a schematic diagram of a map block after switching according to another embodiment of the disclosure; and

FIG. 10D is a schematic diagram of a map block after switching according to another embodiment of the disclosure.

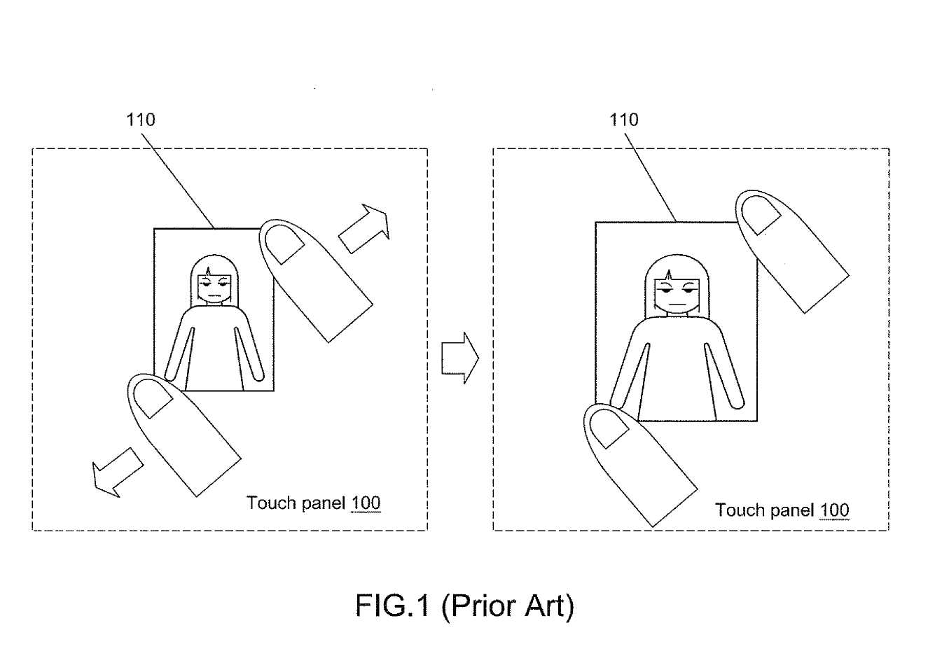

### DETAILED DESCRIPTION

The detailed features and advantages of the disclosure are described below in great detail through the following embodiments, the content of which is sufficient for those of ordinary skill in the art to understand the technical content of the disclosure and to implement the disclosure accordingly. Based upon the content of the specification, the claims, and the drawings, those of ordinary skill in the art can easily understand the relevant objectives and advantages of the disclosure.

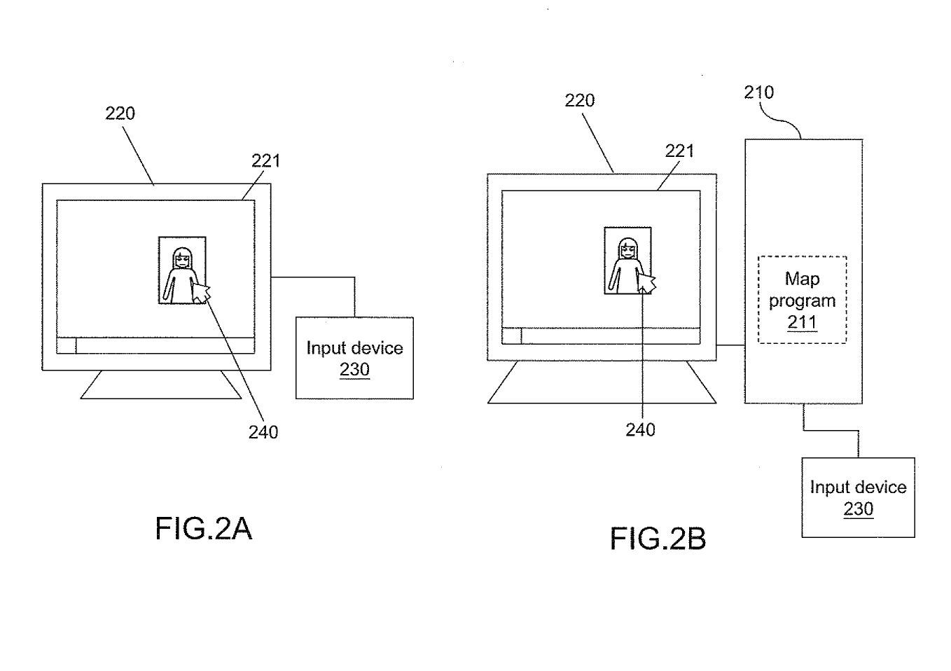

FIGS. 2A and 2B illustrate a schematic framework of an embodiment of the disclosure. The disclosure may be implemented in a display device with computing capability, as shown in FIG. 2A, or in an individual computer. For explanation of the connection and the operation among the components, the embodiment of the individual computer is taken for illustration hereinafter.

A control system of the disclosure includes a computing device 210, a display device 220 and an input device 230. The computing device 210 may be, but not limit to, a personal computer, a server, a notebook or an All-in-one PC. A map program 211 is stored in the computing device 210. The display device 220 communicates with the computing device 210 and displays images outputted by the computing device 210. The outputted image may be a cursor, a desktop image or other objects such as image documents, catalog icons, document icons or application program icons.

Generally, the display region 221 of the display device 220 may include more than one resolution, for example, 800*600 pixels, 1024*768 pixels or 1920*1200 pixels. When executing an operation system, the computing device 210 may acquire the current display region 221 of the display device 220 or the supportable display region 221 through the operation system.

The input device 230 is an electric device with a multi-touch function. The input device 230 may be a personal digital assistant, a digitizer, a mobile phone or a tablet. When the input device 230 is connected to the computing device 210 via universal serial bus (USB) or Bluetooth, the computing device 210 executes the map program 211 to acquire an operation region 231 of the input device 230 and the display region 221 of the display device 220. Therefore, the computing device 210 performs the map program 211 according to the operation region 231 and the display region 221.

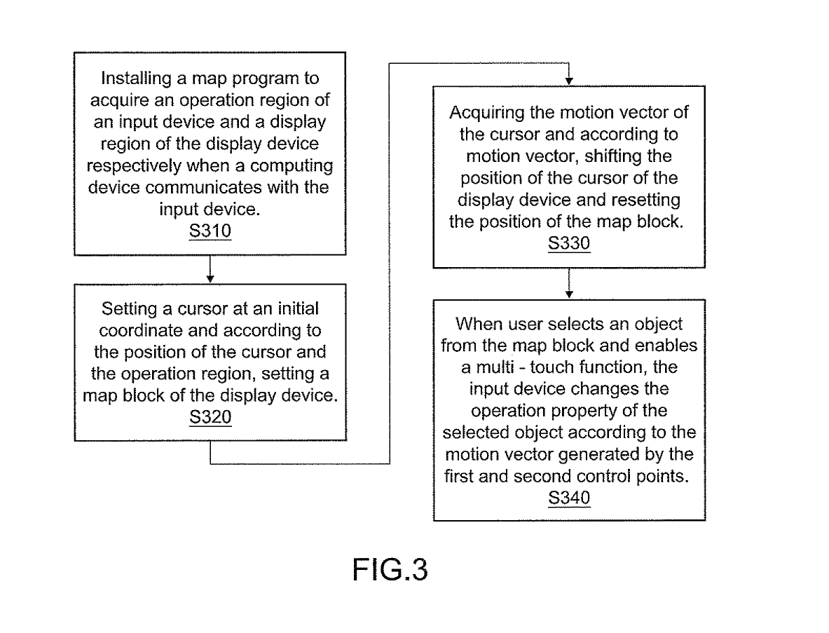

FIG. 3 illustrates a flow chart of an embodiment of the disclosure. When the input device communicates with a computer, a map program is loaded to acquire the operation region of the input device and the display region of the display device respectively, in step S310. A cursor is set at an initial coordinate and thereby a map block is set in the display device according to the cursor and the operation region, in step S320. The input device acquires a motion vector of the cursor. Thereby, the position of the cursor on the display device moves according to the motion vector, and the position of the map block is reset, in step S330. When user selects an object in the map block and a multi-touch function is enabled, the input device changes the operation property of the selected object according to a relative shift quantity generated by a first control point and a second control point, in step S340. The more detail description of the above steps is explained as below.

First, the input device 230 and the display device 220 are respectively connected to the computing device 210, and then the map program 211 initializes the initial positions of the input device 230 and the cursor 240. Because the display region 221 is not equal to the operation region 231, it is necessary to match the cursor 240 and the input device 230 whereby the multi touch control on the input device 230 may correspond to the position of the cursor 240 on the display device 220.

After the computing device 210 is activated and executes the operation system, the computing device may acquire the display region 221 of the display device 220. Therefore, the map program 211 may acquire the current display region 221 from the operation system in order to execute the initial process when the input device 230 is connected to the computing device 210. In another embodiment, the map program 211 may acquire the display region 221 when the input device 230 is installed.

During the initial process of the cursor 240, the position of the cursor 240 may be set at the central, four corners or other position of the display device 220 such that the multi touch control on the input device 230 may be mapped at a specific area of the display device 220. Herein, the position of the cursor 240 is defined as an initial coordinate.

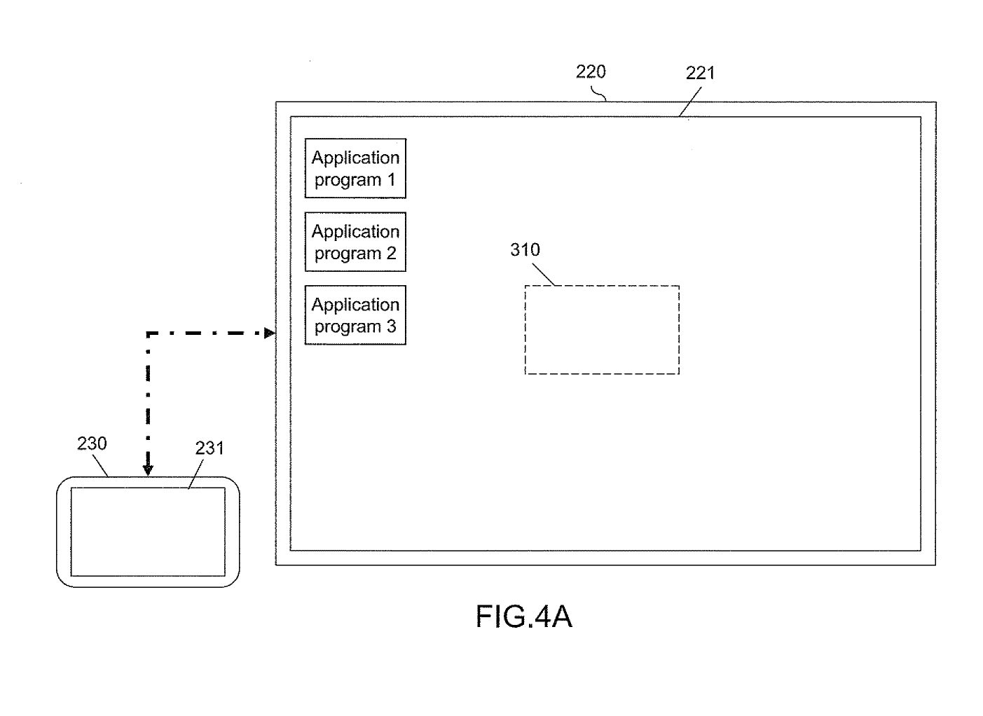

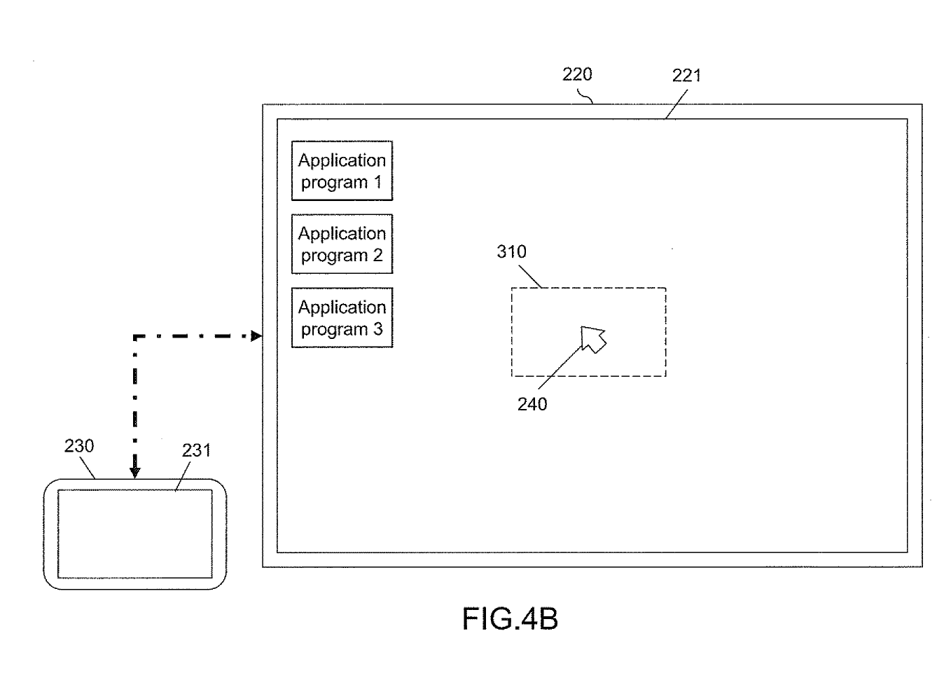

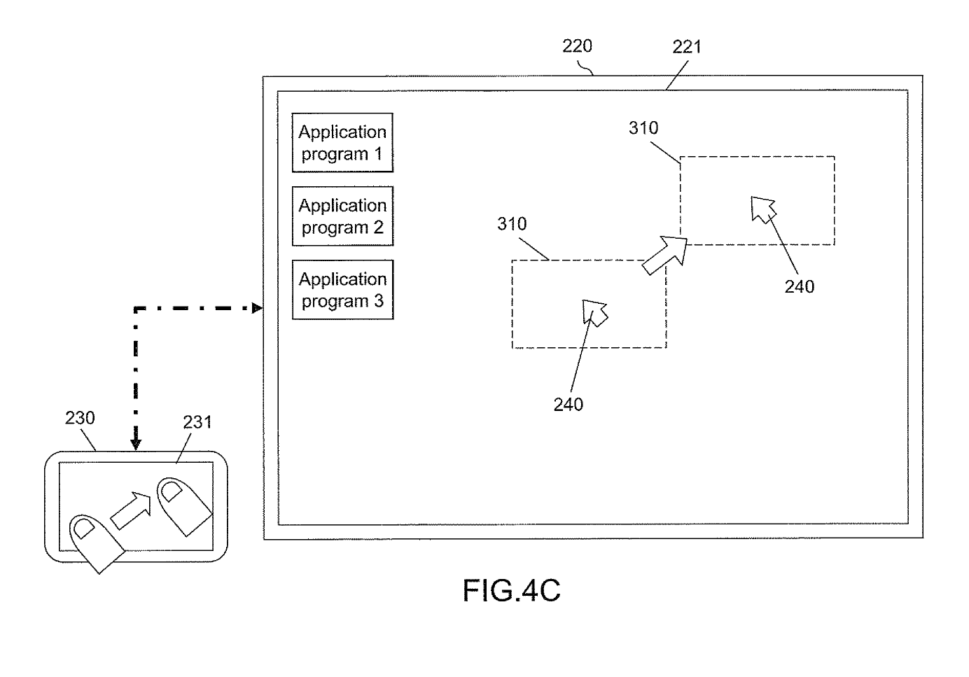

After initializing the position of the cursor 240, the map program 211 sets a map block 310 in the display region 221 according to the position of the cursor 240 is at. The detail description of setting the map block 310 is shown in FIG. 4A.

FIG. 4A illustrates a schematic diagram of a map block according to an embodiment of the disclosure. The map block 310 is not drawn on the display device 220 essentially so is shown in a dotted line. The size of the map block 310 is not only based on the size of the operation region 231 but also based on a mapping relation which the display region 221 provides to the input device 230. To accomplish the mapping relation, the map program 211 generates a block mapping table (not shown) according to the operation region 231 and the display region 221. The block table records an operation region which the map block 310 relative to the display device 220, and records the ratios between the X-axis and Y-axis of the map block 310 and the X-axis and Y-axis of the display region 221.

In one embodiment, when ratios (mapping relation) between X-axes and Y-axes of the map block 310 and display device 220 are respectively 1:1, one pixel of the map block 310 corresponds to one pixel of the display device 220. In another embodiment, when a ratio between X-axes of the map block 310 and display device 220 is 1:1, and a radio between Y-axes of the map block 310 and display device 220 is 1:2, one pixel of the map block 310 corresponds to one pixel of the display device 220, and one pixel of the map block 310 corresponds to two pixels of the display device 220. The above embodiments are examples for describing different mapping relations and should not limit the scope of the disclosure.

After the mapping relation is set in the block table, the computing device 210 sets the map block 310 with the cursor 240 on the display device 220. In FIG. 4B, a schematic diagram of a position of a cursor and of a map block according to an embodiment of the disclosure is shown, and for example but not limit to, the cursor 240 is set at the central of the map block 310.

Referring to FIGS. 4A and 4C, wherein FIG. 4C is the schematic diagram generation of the map blocks during movement of the cursor. The cursor 240 is set at the central of the display region 221 after initializing the cursor 240 and the map block 310 (FIG. 4A). The position of the cursor 240 is referred as the initial coordinate. When user controls the cursor 240 via the input device 230, the computing device 210 acquires a motion vector of the cursor 240 from the input device 230. The motion vector is the vector value relative to the initial coordinate. Moreover, the computing device 210 shifts the position of the cursor 240 on the display device 220 according to the motion vector and resets the position of the map block 310 in the display region 221.

The input device 230 calculates a motion quantity based on the dot per pixel (DPI). The motion quantity of the cursor 240 is adjusted to match the motion quantity of the touch on the input device 230 by which the computing device 210 utilizes the motion vector acquired from the input device 230 to calculates a shift distance on the display device 220 according to the block table.

In one embodiment, the display region 221 of the display device 220 is an image resolution of 1024*768, and the operation region 231 of the input device 230 is 70*50 pixels, where the ratio of X-axis and Y-axis is 1:10. After initializing the cursor 240, the map program 211 shows the cursor 240 at a coordinate of (512, 384) on the display device 220 and sets the coordinate as an initial coordinate. Furthermore, the map program 211 sets the initial coordinate as a center and sets a map block 310 of 70*50 pixels on the display device 220 as shown in FIG. 4C.

When user shifts the cursor 240 via the input device 230, the input device 230 generates a motion vector. In an example of a touch panel as the input device 230, when user presses the touch panel via a finger, the computing device 210 sets the position which user presses, as a basic coordinate. As the finger shifts on the touch panel, the computing device 210 acquires signals outputted from the input device 230 continuously and generates a corresponding motion vector of the cursor 240 according to the basic coordinate and a current coordinate of the finger.

In one embodiment, when the finger of user shifts 10 pixels from left to right along X-axis and 20 pixels from lower to upper along Y-axis from the basic coordinate, and then the computing device 210 may obtain a motion vector (10, 20). Subsequently, based on the motion vector, the computing device 210 shifts the cursor 240 one pixel (10/10=1) from left to right along X-axis and two pixels (20/10=2) form lower to upper along Y-axis on the display device 220. Eventually, the cursor 240 is shifted to a coordinate of (513, 386) on the display device 220.

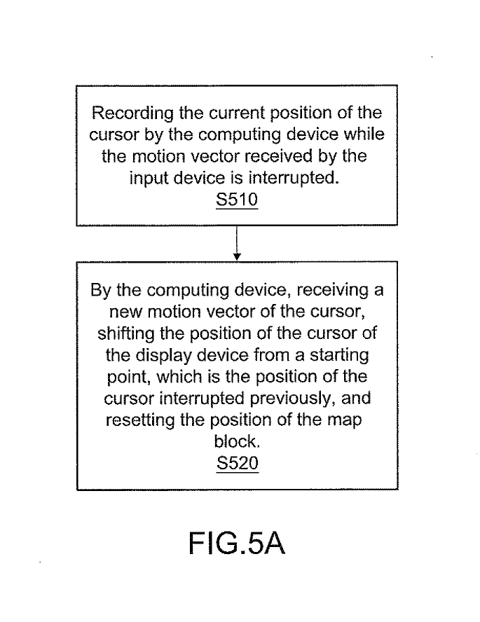

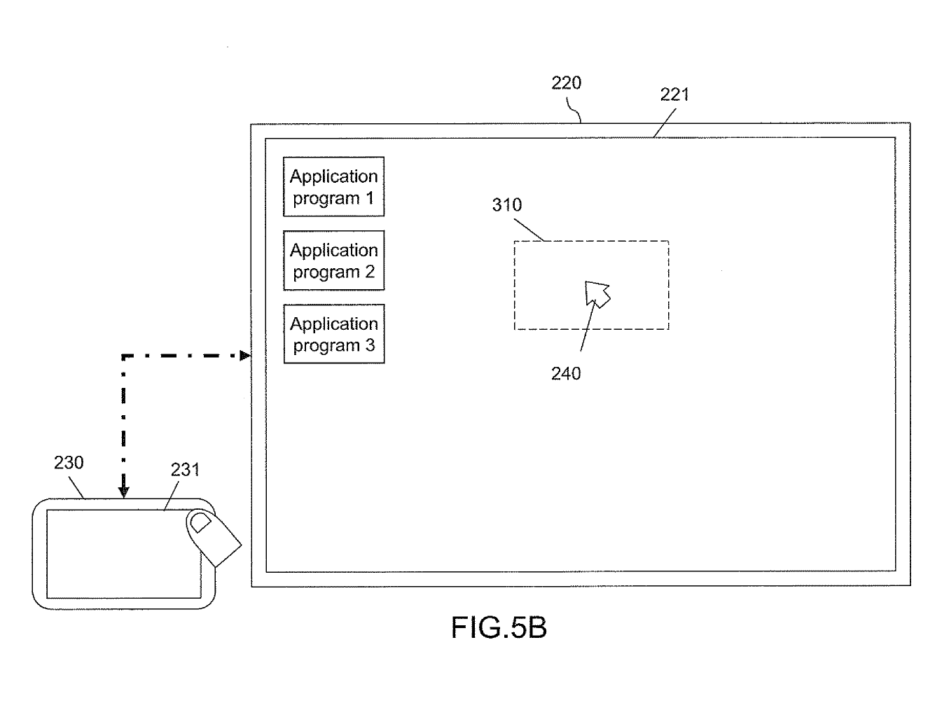

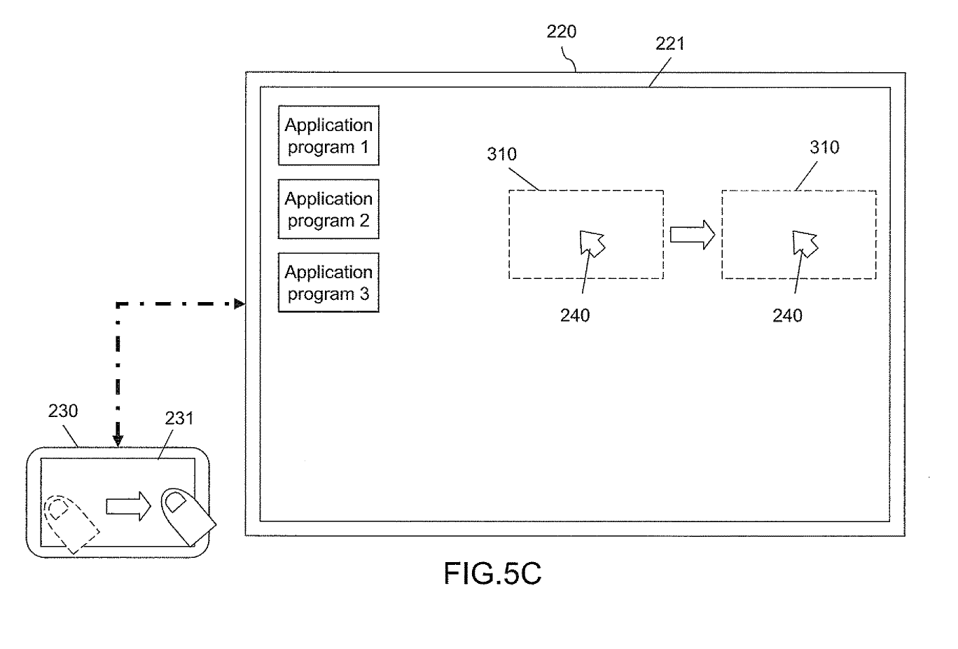

The operation region 231 of the input device 230 is usually smaller than the display region 221 of the display device 220. This situation sometimes causes the shifting of the cursor 240 being interrupted when user's finger shifts to the edge of the operation 231. For continuously shifting the cursor 240 and the map block 310, the disclosure further provides an interruption procedure shown in FIGS. 5A to 5C and described as below.

When the motion vector of the cursor received by the input device is interrupted, the position of the cursor interrupted to shift is recorded by the computer, in step S510. Subsequently, a new motion vector of the cursor is received, and the computing device sets the position, which the cursor is interrupted to shift previously, as an initial point. The computing device then shifts the cursor on the display device according to the new motion vector, and resets the position of the map block, in step S520. The more detail description of the above steps is explained as below.

When user's finger shifts to the edge of the input device 230 as shown in FIG. 5B, user may not shift the cursor 240 and has to withdraw the finger. Herein, the computing device 210 records the current position of the cursor 240. User further puts the finger anywhere on the operation region 231 of the input device 230 to continuously shift the cursor 240 as shown in FIG. 5C. The dotted line with a finger shape in FIG. 5C indicates the position before the finger shifted. Therefore, the computing device 210 may receive a new motion vector of the cursor 240, and sets the position, which the cursor 240 is interrupted to shift previously, as the initial point. Moreover, the computing device 210 shifts the cursor 240 on the display device 220 according to the new motion vector and resets the position of the map block 310. The map block 310 is shifted to a new position. Therefore, the position which the finger presses on the input device 230 and the position of the map block 310 may be synchronized.

Subsequently, user selects one desired object 610 in the map block 310 and enables the multi-touch function. User can use one finger to click at the position of one object 610 on the map block 310 to select the object 610. Furthermore, user presses the input device 230 via a first finger, where the first pressed position is defined as a first control point. User presses the input device 230 via a second finger, where the second pressed position is defined as a second control point. When the computing device 210 receives the signals of the first and second control points simultaneously, the multi-touch function is enabled.

When the computing device 210 detects that the multi-touch function is enabled, the input device 230 obtains a relative shift quantity formed by the positions. The computing device 210 then changes the operation property of the object 610 according to the relative shift quantity. The operation property may include a coordinate of the object 610, the range of the display region 221 or a rotation angle.

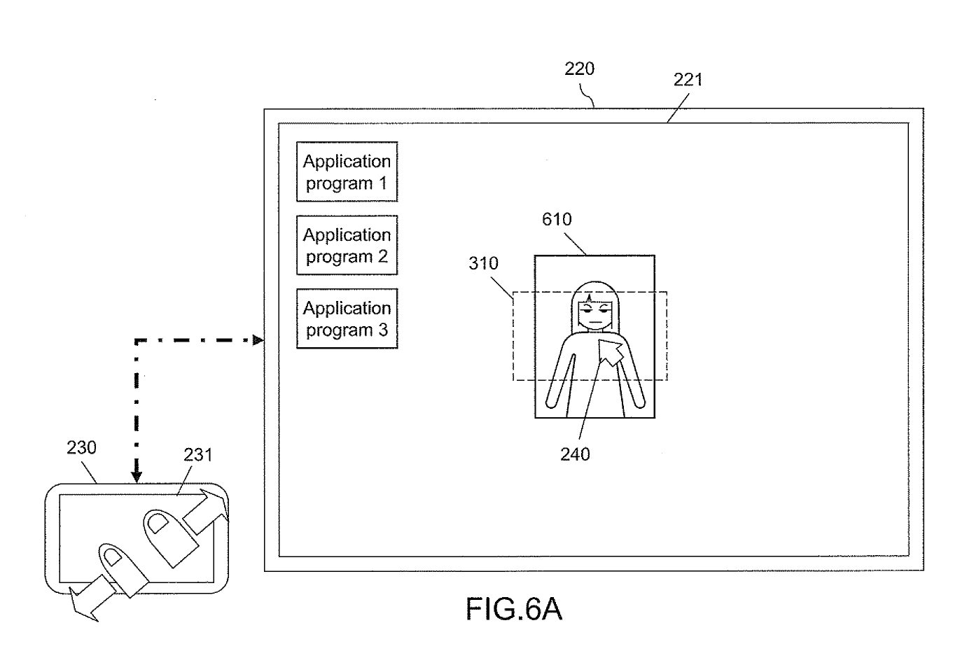

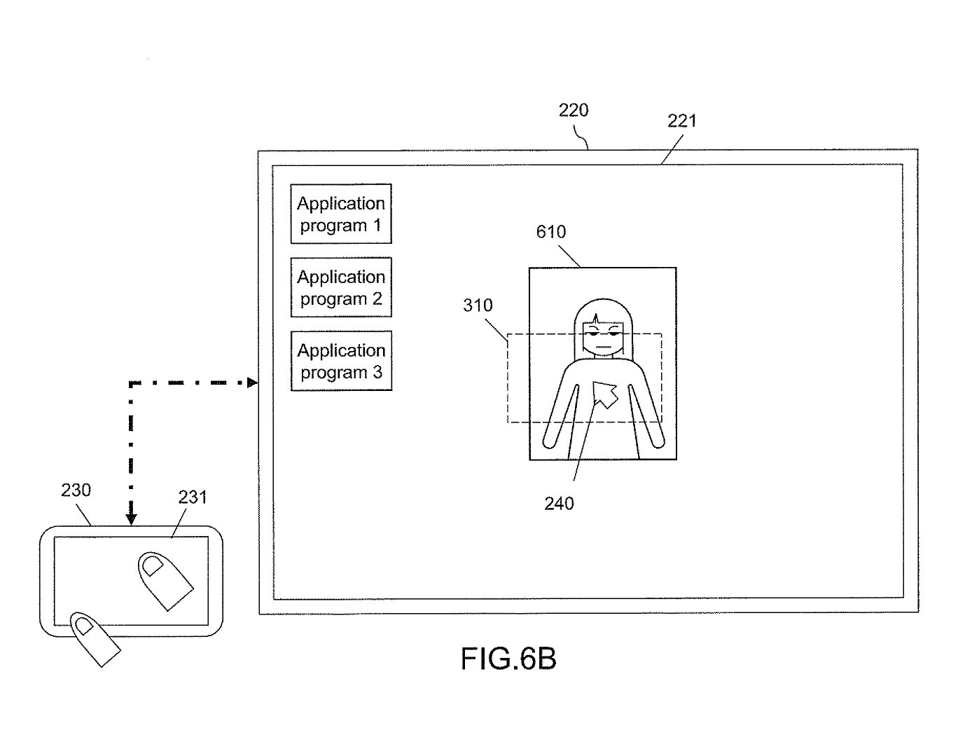

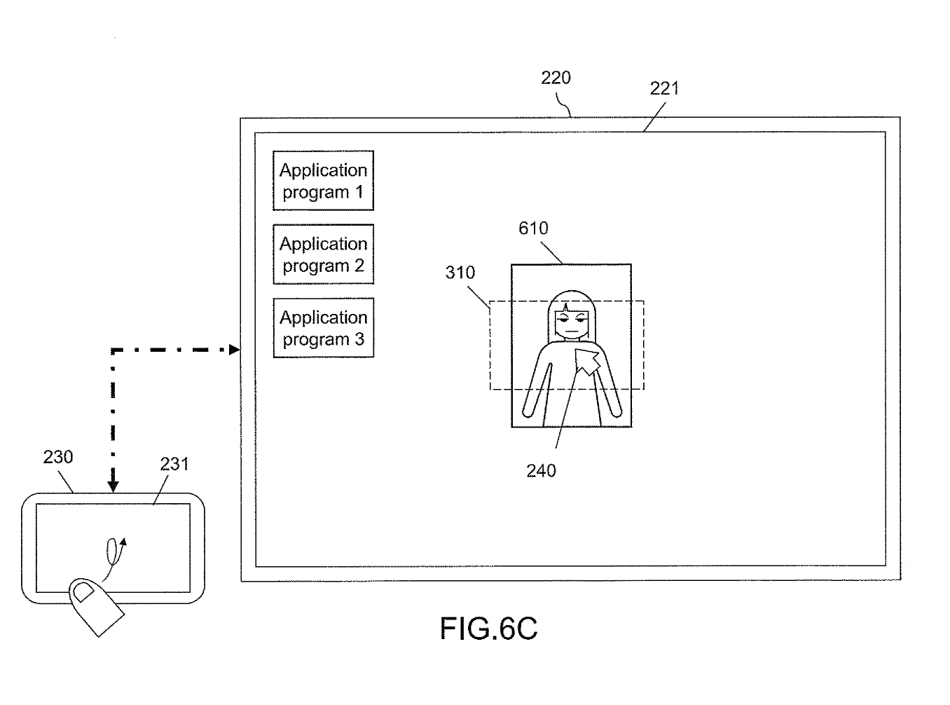

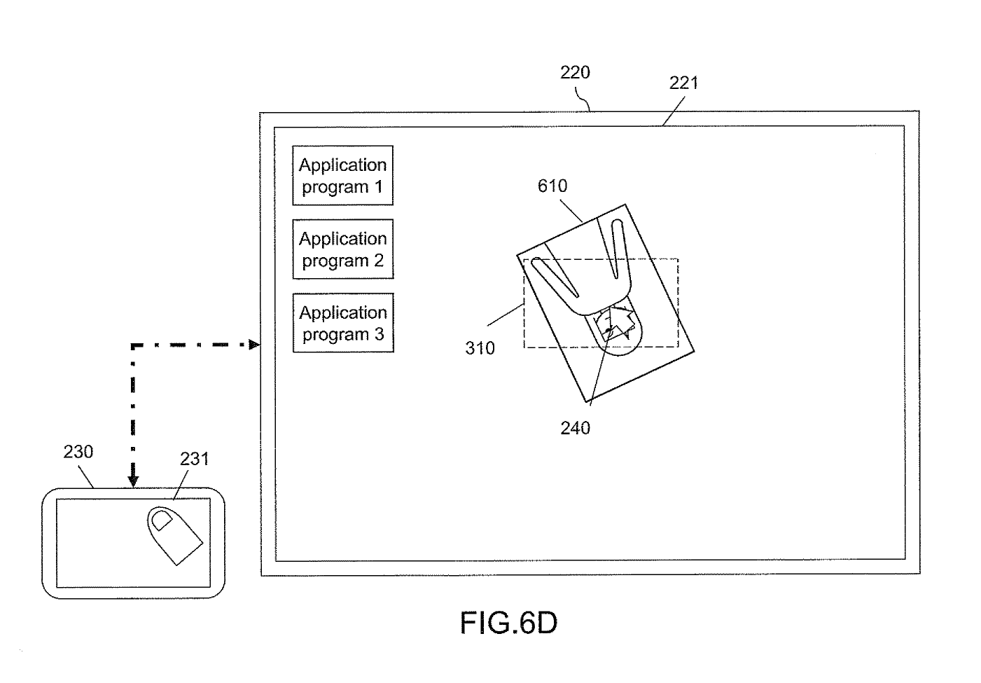

In one embodiment, user can change an image size of the object 610 through a shift distance between two fingers, i.e. the first control point and the second control point received by the input device 230 as shown in FIGS. 6A and 6B. In another embodiment, use can rotate the object 610 through the variation of the relative position between the first and second control points as shown in FIGS. 6C and 6D.

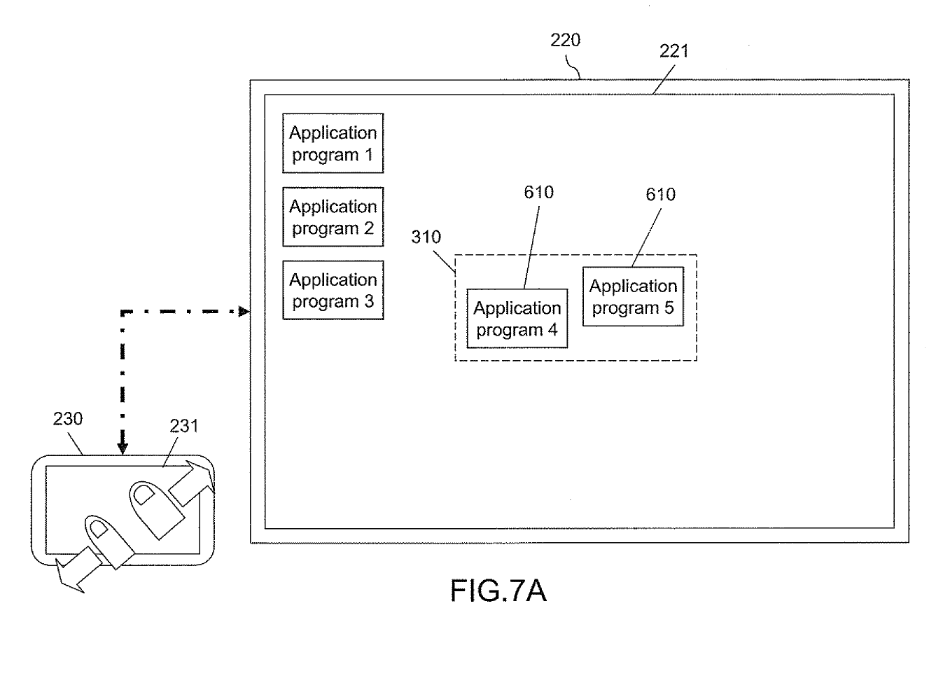

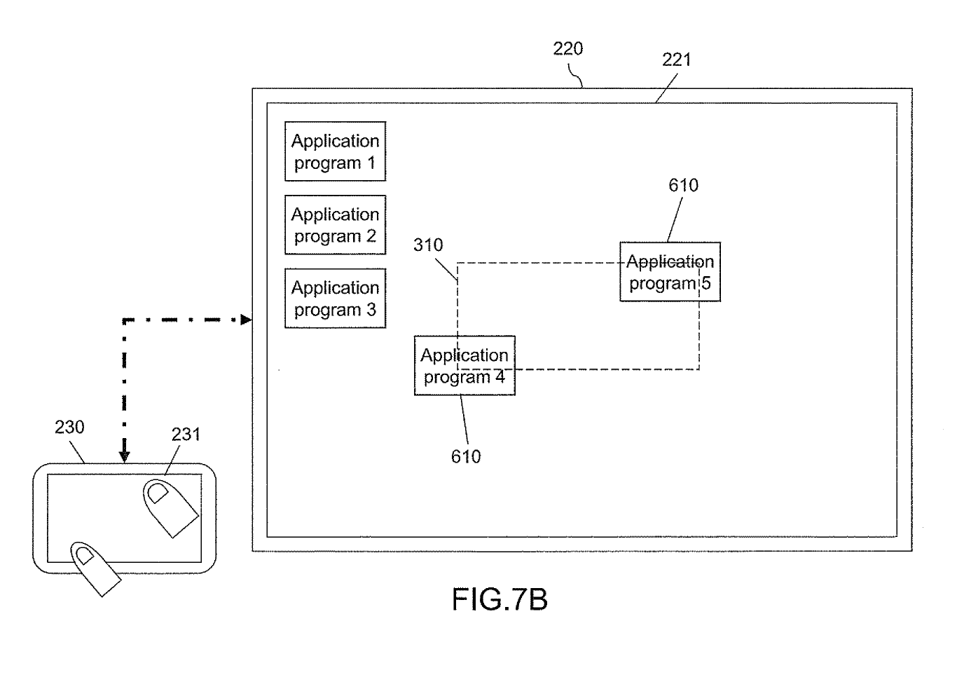

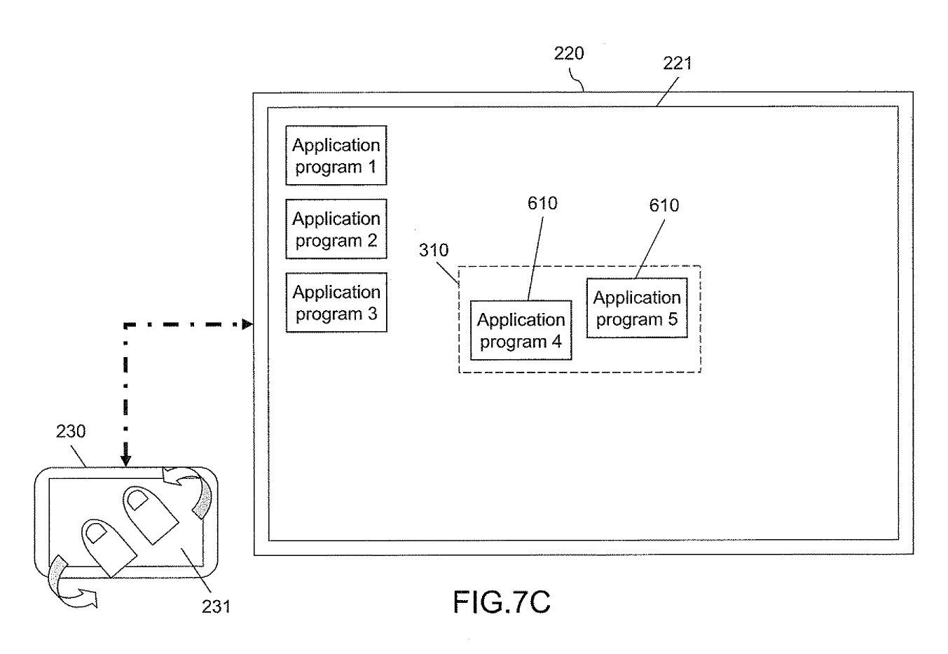

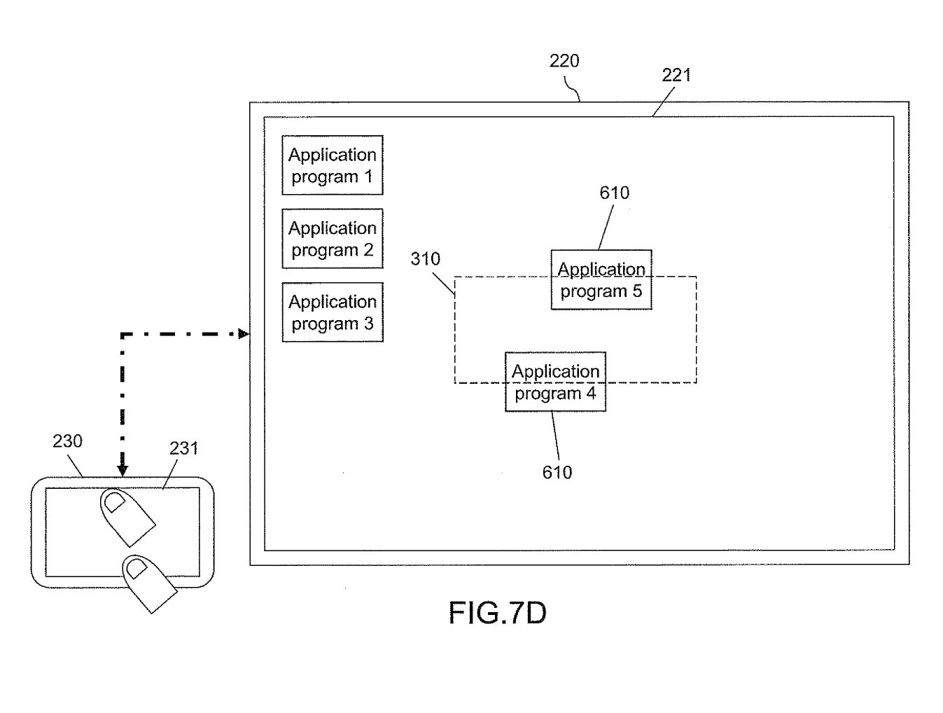

Besides the disclosure implementing to the embodiment for controlling a single object 610 in the map block 310, the disclosure may be further implemented to another embodiment for controlling more than two objects 610 in the map block 310 as shown in FIGS. 7A and 7B. The detail operation is described as below.

When the map block 310 includes multiple objects 610, user firstly selects one of the objects 610 in the map block 310. User uses one finger to click the position of the object 610 to generate a trigger signal. Then, user uses another finger to press another position on the input device 230 to enable the multi-touch function.

After the multi-touch function is enabled, the computing device 210 rotates or shifts the selected object 610 according to the shift variation between the first and second control points. Different embodiments of multiple objects 610 rotating in the map block 310 are shown in FIGS. 7C and 7D. When user's another finger presses at other object 610, the computing device 210 changes the positions of two objects 610 according to the shift differences between the two fingers.

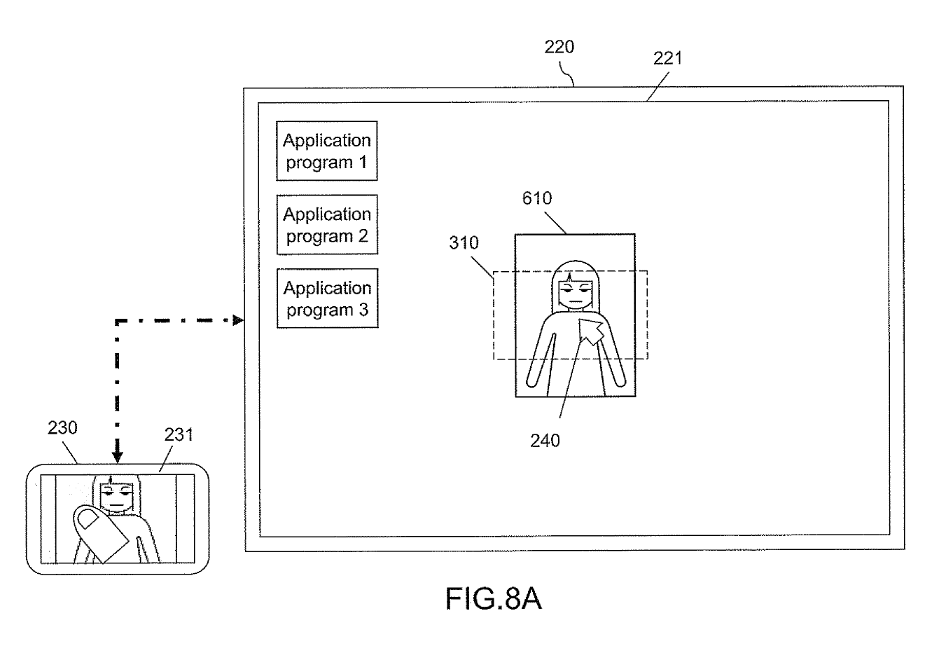

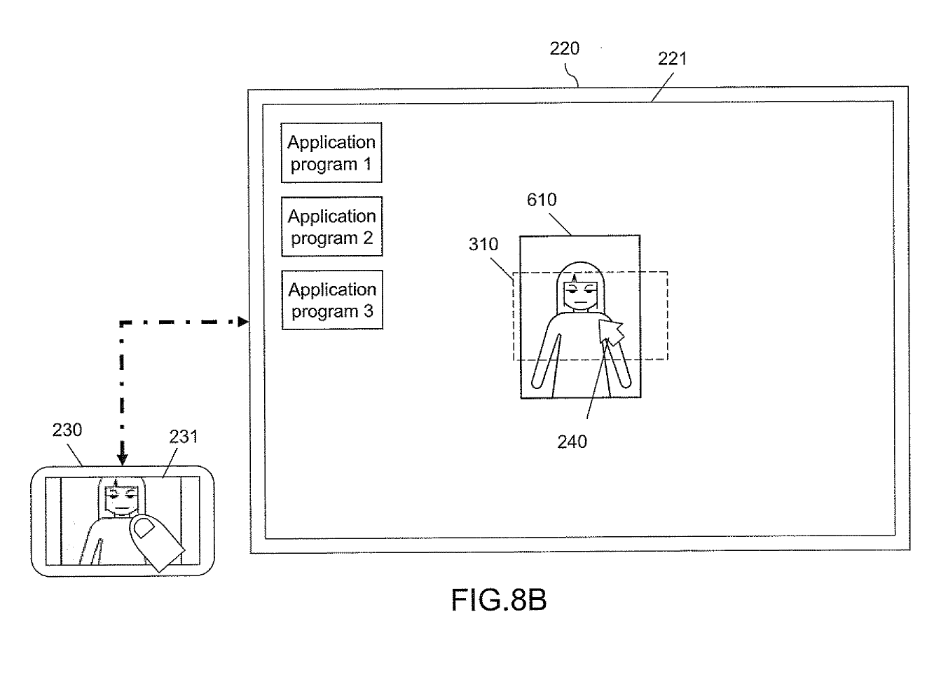

The above embodiments are based on the input device 230 without an image display function. However, the disclosure may be further implemented to an input device 230 with the image display function as shown in FIGS. 8A and 8B. The input device 230 with the image display function may be, but not limit to, a tablet or a touch mobile phone. The computer 210 transmits images in the map block 310 to the input device 230 immediately after setting the map block 310. While the cursor 240 and the map block 310 are shifting, the computer 210 transmits images in the map block 310 to the input device 230.

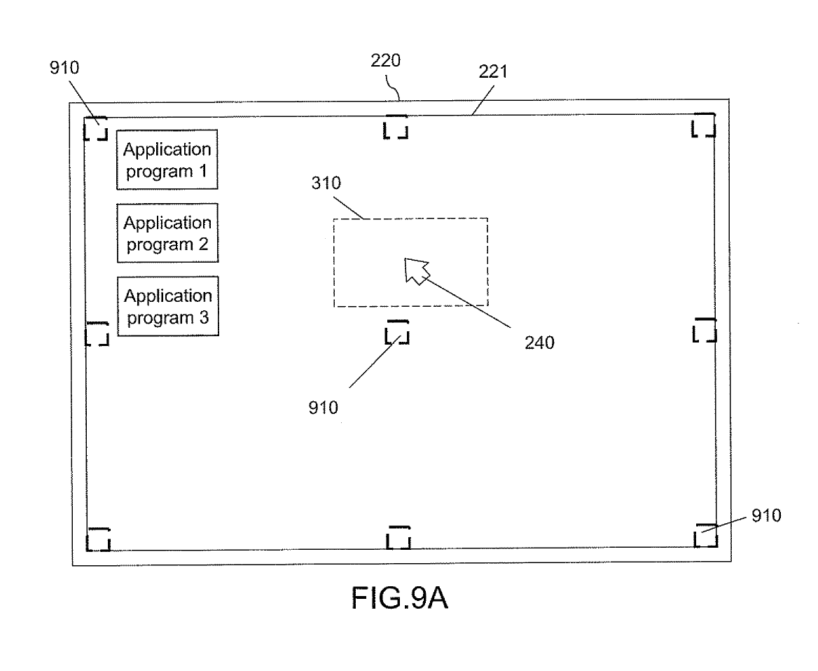

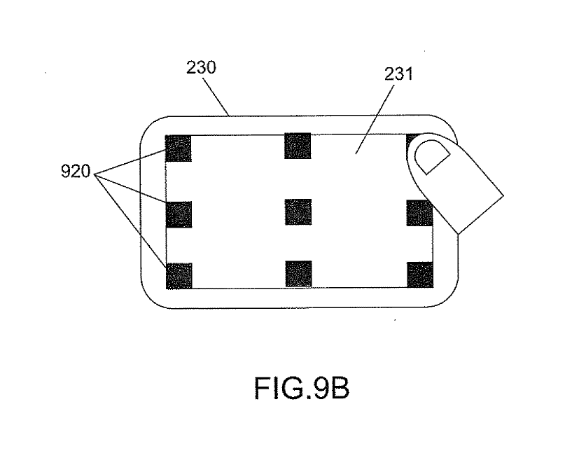

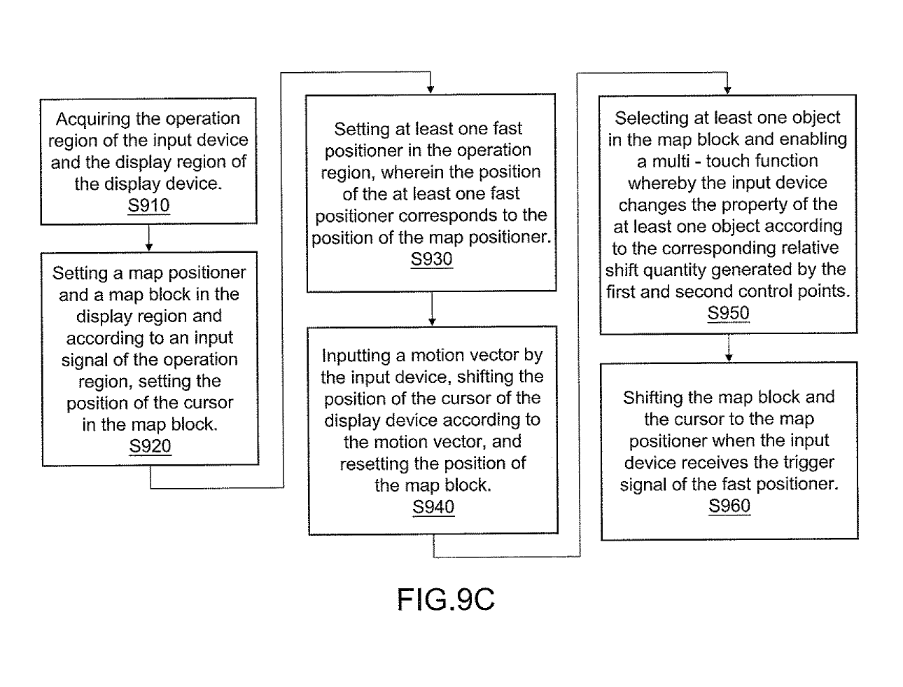

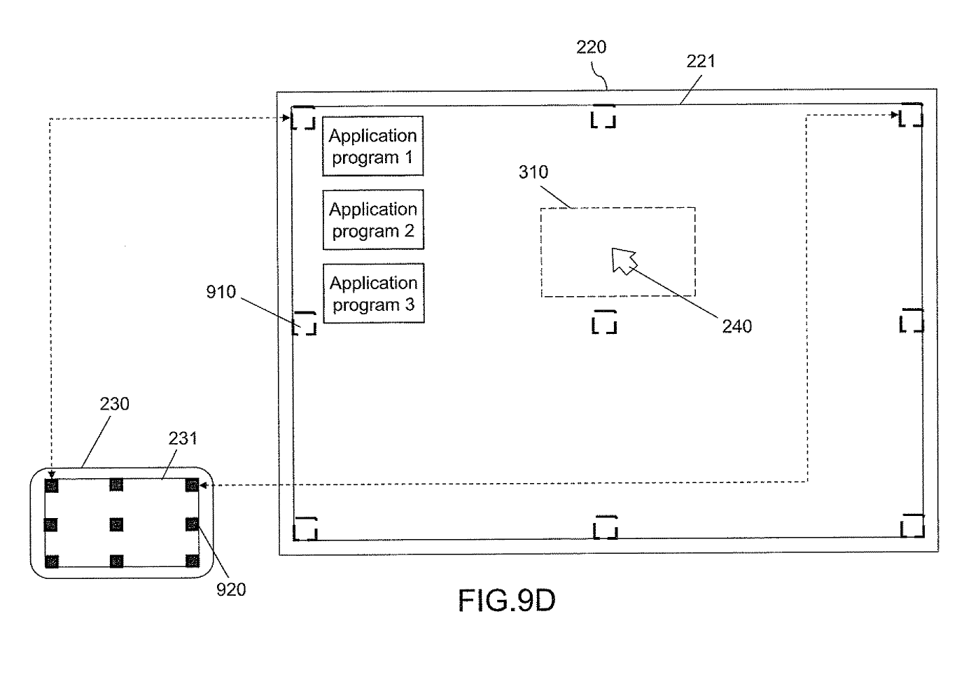

Moreover, the disclosure further provides another embodiment of the control system to fast switch the map block 310 in the display region 221. The embodiment includes a computing device 210, a display device 220 and an input device 230. The display region 221 of the display device 220 further comprises at least one map positioner 910 shown in FIG. 9A. The map positioner 910 may be set anywhere in the display region 221. The operation region 231 of the input device 230 further comprises at lest one fast positioner shown in FIG. 9B. The amount of the map positioners 910 is equal to the amount of the fast positioners 920. The position of each of the fast positioners 920 corresponds to the position of each of the map positioners 910, but such an embodiment should not limit the scope of the disclosure.

Referring to FIG. 9C, the procedure of processing the fast positioners 920 and the cursor 240 of the map block 910 is shown. In the step S910, the operation region of the input device and the display region of the display device are acquired. In step S920, at lest one map positioner and a map block are set in the display region, and the position of the cursor and the map block are set according to an input signal generated by the operation region. In step S930, at least one fast positioner is set in the operation region, and the position of the at least fast positioner corresponds to the position of the at least one map positioner. In step S940, a motion vector is inputted by the input device, the position of the cursor is shifted according to the motion vector, and the position of the map block is reset. In step S960, at least one object in the map block is selected, a multi-touch function is enabled, and the input device changes the operation property of the selected object according to a relative shift quantity formed by a first control point and a second control point. The input device sets the current position of the cursor as the first control point. The second control point is another position different from the first control point. In step S950, when the input device receives a trigger signal generated from the fast positioner, the map block and the cursor are shifted to the map positioner. The detail operation is described as below.

The display device further includes at least one map positioner, the operation region includes at least one fast positioner, and the position of the at least one map positioner corresponds to the position of the at least one fast positioner, that is, the position of the at least one fast positioner in the operation region can be shown at a corresponding position, where the at least one map positioner is at, in the display region. In one embodiment, the at least one map positioner and the at least one fast positioner may be displayed in a practical way such as transparent blocks. In another embodiment, the at least one map positioner and the at least fast positioner may not be displayed.

For an example shown in FIG. 9D, the operation region 231 includes nine fast positioners 920 (shown as black blocks), and the display region 221 includes nine map block 910 (dotted line blocks). The number and positions of the fast positioners 920 and map blocks 910 are designed based on products requirement and should not be a limit of the disclosure. The positions of the nine fast positioners 920 are similar, and the dotted lines indicate the relation between the fast positioners 920 and the map blocks 910. The fast positioner 920 at the upper-left corner of the operation region 231 corresponds to the map block 910 at the upper-left corner of the display region 221. Likewise, the fast positioner 920 at the upper-right corner of the operation region 231 corresponds to the map block 910 at the upper-right corner of the display region 221.

When the input device 230 acquires a motion vector of the cursor 240, the display device 220 simultaneously shifts the cursor 240 on the display region 221 according to the received motion vector and sets the corresponding map block 310 according to the position of the cursor 240. When user selects at least one object in the map block 310 and enables the multi-touch function, the input device 230 may change the operation property of the selected object according to a relative shift quantity (the motion vector) formed by the first control point and the second control point.

In order that the input device 230 controls the cursor 240 faster, the disclosure further provides a manner by which the positions of the cursor 240 and map block 310 can be changed fast in the display region 221. When the input device 230 receives a trigger signal from one fast positioner 920, the positions of the map block 310 and the cursor 240 may be shifted to the position of the corresponding map positioner 910 simultaneously, where the trigger signal may be formed by pressing for a while or by a function key. In one embodiment of a function key, when user presses the Ctrl key and clicks a fast positioning key, the cursor 240 is directly shifted to the position of the corresponding map block 910, and the position of the map block 310 is reset according to the position of the cursor 240.

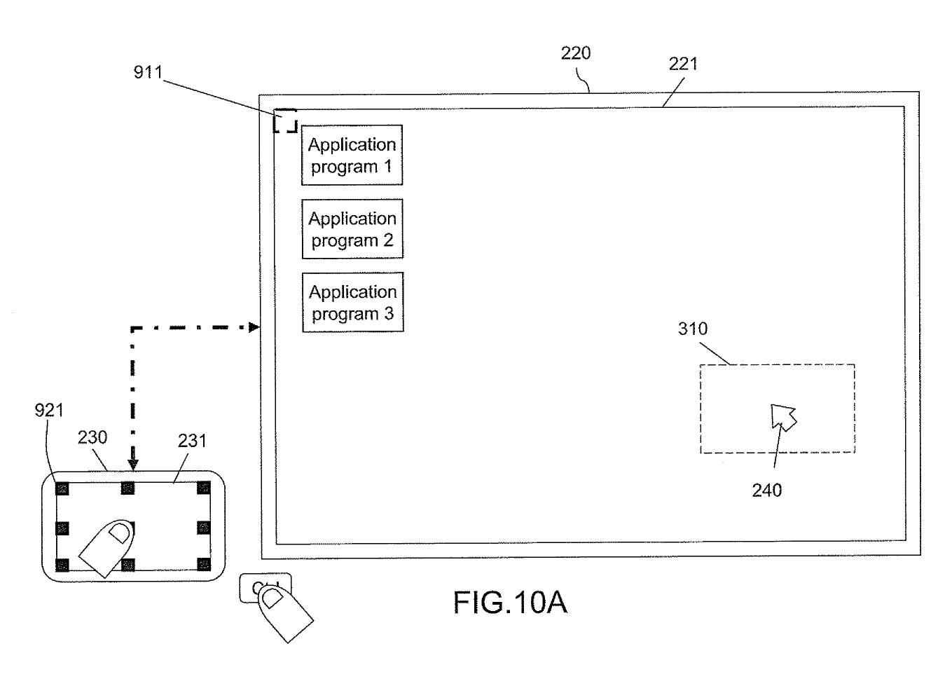

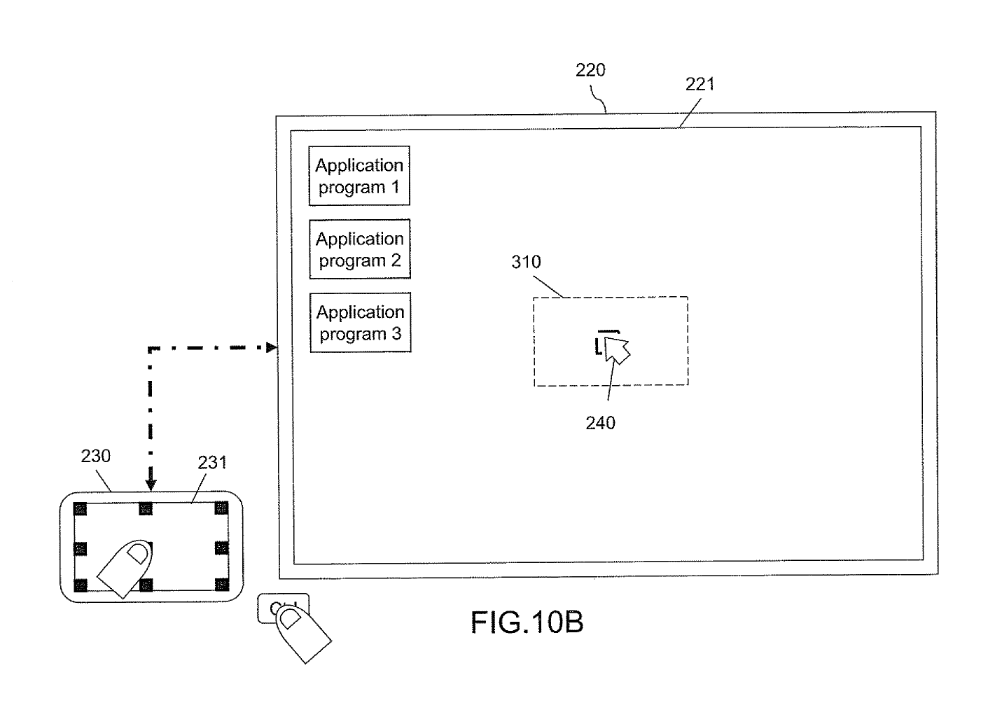

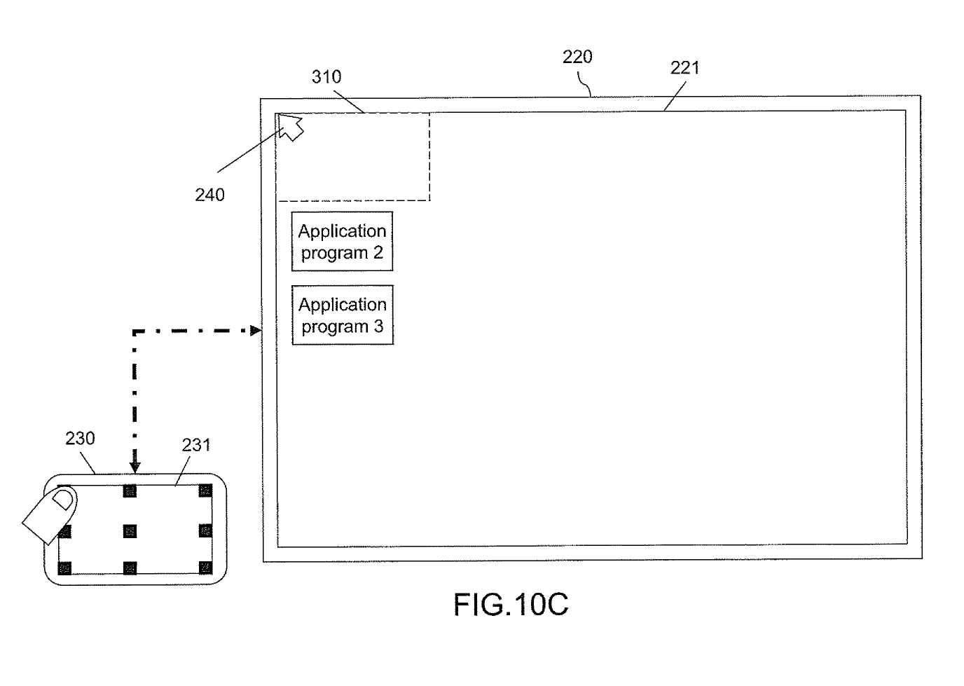

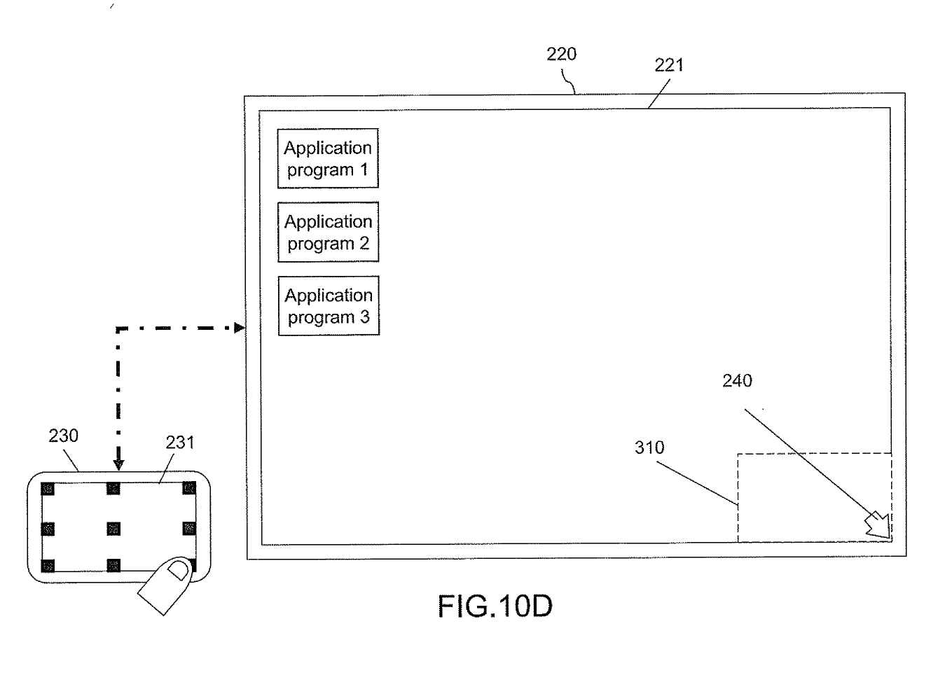

Referring to FIGS. 10A and 10B, when the cursor 240 is at the position of FIG. 10A and user wants to fast shift the cursor 240 and the map block 310 to the position of the map position 910 in the display region 221, user can press the Ctrl key and click the fast positioner 920 in the central of the display region 221 through the input device 230. The cursor 240 on the display device 220 is directly shifted from the position of FIG. 10A to the position of FIG. 10B, and the position of the map block 310 is reset according to the position of the cursor 240 of FIG. 10B.

In one embodiment, the map block 910 at the upper-left corner of the display region 221 is defined as a first map positioner 911, and the corresponding fast positioner 920 is defined as a first fast positioner 921. When the input device 230 detects a signal from the first fast positioner 921, the display device 220 shifts the cursor 240 to the position of the first map positioner 911 synchronously. To avoid the map block 310 crosses the edge of the display region 221, the display device 220 may set the cursor 240 at the upper-left corner of the map block 310 and then sets a new map block 310 shown as FIG. 10C.

Likewise, when the input device 230 receives a trigger signal from the fast positioner 920 at the lower-right corner in FIG. 10A, the display device 220 shifts the cursor 240 to the position of the corresponding map block 910 at the lower-right corner. Moreover, the display device 220 also sets the cursor 240 at the lower-right corner of the map block 310 according to the position of the cursor 240 in FIG. 10D.

The disclosure provides a manner by which the input device with smaller operation region cooperates with the display device with larger display region to enable the multi-touch function. User can shift the cursor on the display device via the input device. When the input device keeps receiving the cursor shift signal, the map program may transform the cursor shift signal of the input device to the motion vector of the display device according to the block table. User can utilize the multi-touch function of the input device to control the objects on the screen of the display device. Fast positioners may be set on the input device. Therefore, when user triggers different fast positioners, the cursor and the map block are simultaneously shifted to the corresponding positions on the display device.

The disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and region of equivalency of the claims are to be embraced within their scope.

What is claimed is:

1. An operation method for multi-touch control, controlling a cursor of a display device by an input device with a multi-touch function and comprising:
acquiring an operation region of the input device and a display region of the display device;
setting at least one map positioner and a map block in the display region and setting a position of the cursor of the map block according to an input signal of the display region;
setting at least one fast positioner in the operation region, wherein the position of the at least one fast positioner corresponds to the position of the at least one map positioner;
inputting a motion vector of the cursor by the input device, shifting the position of the cursor on the display device according to the motion vector of the cursor, and resetting a position of the map block;
selecting at least one object in the map block, enabling the multi-touch function, and by the input device, changing an operation property of the selected object according to a relative shift quantity formed by a first control point and a second control point, wherein the input device sets a current position of the cursor as the first control point, and the position of the second control point differs from the position of the first control point; and
shifting the map block and the cursor to the corresponding map positioner when the input device receives a trigger signal of the at least one fast positioner.

2. The operation method for multi-touch control according to claim 1, wherein the step of setting the at least one map block comprises:
generating a block table according to the operation region and the display region;
acquiring a region of the map block from the block table; and
setting the map block comprising the cursor on the display device.

3. The operation method for multi-touch control according to claim 1, wherein the step of inputting the motion vector comprises:
generating a block table according to the operation region and the display region; and
acquiring the motion vector from the input device and according to the block table, calculating a shift distance of the cursor shifting on the display device.

4. The operation method for multi-touch control according to claim 3, wherein the step of inputting the motion vector further comprises:
recording an interrupted position of the cursor after the motion vector received by the input device is interrupted; and
receiving a new motion vector to shifting the cursor of the display device from the interrupted position according to the new motion vector, and resetting a position of the map block.

5. The operation method for multi-touch control according to claim 1, wherein the operation property of the object is a coordinate position, a display region or a rotation angle.

6. The operation method for multi-touch control according to claim 1, wherein the input device comprises a display function, and when the display device sets the map block, transmitting and drawing an image in the map block to the input device.

7. The operation method for multi-touch control according to claim 6, wherein when the motion vector is inputted, the position of the map block of the display device is reset, and the image in the map block is drawn to the input device.

8. The operation method for multi-touch control according to claim 1, wherein the display device communicates with the input device via a computing device.

9. A control system for multi-touch control, comprising:
a display device, comprising a display region which a cursor is drawn in comprising at least one map positioner;
a computer, electronically connected to the display device, for receiving a cursor shift signal to redraw a position of the cursor in the display region; and
an input device, connected to the computer and comprising at least one fast positioner, for display an operation region, receiving the cursor shift signal by the operation region, generating a motion vector of the cursor according to the cursor shift signal, and shifting a map block and the cursor to the at least one map positioner when receiving a trigger signal of the at least one fast positioner, wherein the position of the at least one fast positioner corresponds to the position of the at least one map positioner.

10. The control system for multi-touch control according to claim 9, wherein an amount of the at least one fast positioner corresponds to an amount of the at least one map positioner.
